(19) United States
(12) Patent Application Publication
(10) Pub. No.: US 2004/0039594 A1
(43) Pub. Date: Feb. 26, 2004

(54) Systems and methods for dynamically generating licenses in a rights management system

(75) Inventors: Anand Narasimhan, Berkeley, CA (US); Doron Myersdorf, Forest City, CA (US); Srikanth Ranganathan, San Jose, CA (US); Ray Dickenson, Scotts Valley, CA (US)

Correspondence Address: FOLEY & LARDNER, 2029 CENTURY PARK EAST, SUITE 3500, LOS ANGELES, CA, 90067

(73) Assignee: InnerPresence Networks, Inc.

(21) Appl. No.: 10/460,738

(22) Filed: Jun. 12, 2003

Related U.S. Application Data
(63) Continuation-in-part of application No. 10/339,925, filed on Jan. 9, 2003.
(60) Provisional application No. 60/387,737, filed on Jun. 11, 2002.
(60) Provisional application No. 60/347,124, filed on Jan. 9, 2002.
(60) Provisional application No. 60/347,125, filed on Jan. 9, 2002.

(51) Int. Cl. G06F 17/60

(52) U.S. Cl. 705/1

(57) ABSTRACT

Policies that govern the rights of system assets with respect to other system assets are enforced through dynamic generation of a license at a policy engine in response to a request by an asset to exercise a right with respect to another asset. The system assets are objects within the system to which behavior-regulating policies are applied. Typical types of system assets include users, devices, information files, and processes, and many other types of assets may also be defined. Upon receiving a request to exercise a right, the policy engine obtains predefined policies that are relevant to the request, and obtains factual information for evaluating the current state of transient conditions upon which rights are contingent as expressed in the policies. Through evaluation of the policies, the policy engine generates a license that expresses rights or prohibitions of the requesting asset with respect to another specified asset.

### RELATED APPLICATIONS

This application is a continuation-in-part of U.S. non-provisional application Ser. No. 10/339,925 filed Jan. 9, 2003, the entirety of which is incorporated herein by reference.

This application claims priority under 35 USC §119(e) from U.S. provisional application No. 60/387,737 filed Jun. 11, 2002, the entirety of which is incorporated herein by reference.

This application is related to U.S. provisional application No. 60/347,124 filed Jan. 9, 2002, and U.S. provisional application No. 60/347,125 filed Jan. 9, 2002, the entirety of each of which is incorporated herein by reference.

### BACKGROUND OF THE INVENTION

1. Field of the Invention

Embodiments of the invention relate to electronic systems such as communication networks, computer systems and electronic monitoring systems, and more particularly to the enforcement of policies governing rights exercisable by system assets such as users and processes with regard to other system assets such as documents, devices and information files.

2. Related Technology

Computer systems and communication networks involve valuable assets. Such assets include information files such as documents and media files, as well as communication channels and devices. A variety of systems for providing security in computer systems and communication networks are known.

One security system takes a user or device-oriented approach, whereby obstacles are created to prevent unauthorized users from using devices that provide entry to the system. For example, user authentication systems such as computer network passwords and public key encryption may be employed to ensure that only certain individuals are able to use certain devices and obtain access to certain information. However, a user who has been authenticated by providing an appropriate user id and password or an appropriate decryption key is thereafter free to access and distribute information and engage in other unregulated uses of the system. Therefore this approach cannot eliminate threats from malicious users or negligent policy breaches by valid users.

Another approach to security is content filtering. For example, an email security system may filter the content of email messages sent into and out of the system by searching for fixed character strings within email messages. However, such filtering is done without regard to the identity of the sender or receiver, or to the devices to which and from which the messages are transmitted.

A third approach to security involves monitoring accesses to information files. For example, document management systems provide a central repository for storing information files, and provide monitoring of accesses to and actions taken with respect to documents. However these systems provide little control over the use of accessed documents, and so once a document is accessed, the user is free to print, make copies of, alter or disseminate the document in an unregulated manner.

A fourth approach to security is commonly referred to as digital rights management. The conventional digital rights management scheme attaches to each information file a license that specifies the user who may use the information file, where it may be used and how often it may be used. The uses of the information file are thereafter restricted in accordance with the rights expressed in the license. The restrictions may be enforced, for example, by the application that is used to access the information file, or by the operating system of the device that is used to access the information file. However, the conventional digital rights management approach is static and user- and device-centric, in that the rights expressed in the license attached to an information file are customized in advance for a particular user and device, and thereafter remain unchanged for that instance of the information file.

The aforementioned approaches to security all suffer in that they are not able to apply abstract business-level rules and policies to a variety of users, devices, processes, and information assets under changing circumstances. Rather, the aforementioned approaches are essentially static in the conditions to which they are applicable.

### SUMMARY OF THE INVENTION

Embodiments of the invention pertain generally to enforcing policies that govern the rights of system assets with respect to other system assets through licenses that are dynamically generated in-response to a request by an asset to exercise a right with respect to another asset. The rights conferred by the dynamically generated licenses are customized to the particular combination of assets specified in the request in accordance with policies that govern each of the specified assets and the current state of transient conditions upon whose state the exercise of the right is contingent.

In accordance with embodiments of the invention, a system is treated as including “assets,” which are objects within the system to which behavior-regulating policies are applied. In accordance with a preferred embodiment, system assets may include users, devices, information files, and processes. Other types of assets may also be defined.

The system preferably includes a policy engine for dynamically generating licenses in response to requests from assets to exercise rights with respect to other assets. In the preferred embodiment, a request typically specifies a user or process that wishes to exercise a right, an information file with respect to which the right is to be exercised, the right that is desired to be exercised, and a device at which the right will be exercised. In response to the request, the policy engine obtains predefined policies that are relevant to the request, and obtains factual information for evaluating the current state of transient conditions upon which rights are contingent as expressed in the policies. Through evaluation of the policies, the policy engine generates a license that expresses rights or prohibitions of the requesting user or process with respect to the specified information file.

The policy engine of the preferred embodiment is preferably deployed in a policy management server as a server agent that receives requests and provides licenses in response. In other embodiments, a policy engine may be deployed in a client device. Issuance of requests and receipt and enforcement of licenses is preferably implemented in client agents that are resident on or associated with each device in the system. The client agents preferably provide additional services such as a policy creation service that may be used by users to establish policies governing their information files. The server agent preferably provides additional services such as auditing of license generation and policy application, simulation of policy effects for evaluation of proposed policies based on current activities or prior activities, monitoring of the uses of system assets to determine the levels of protection that are appropriate to those assets based on the monitored activities, and automatic creation and modification of policies based on monitored activities.

### DESCRIPTION OF THE DRAWINGS

Preferred embodiments of the invention are described in conjunction with the following figures, in which:

FIG. 1 shows an schematic representation of basic components of a dynamic license generation system;

FIG. 2 shows an exemplary administrative hierarchy of a preferred embodiment;

FIG. 3 shows an exemplary device hierarchy of a preferred embodiment;

FIG. 4 shows an exemplary information file hierarchy of a preferred embodiment;

FIG. 5 shows the creation of policy stacks in hierarchies of a preferred embodiment;

FIG. 6 shows a standardized form of a rule in a preferred embodiment;

FIG. 7 shows an exemplary policy in a preferred embodiment;

FIG. 8 shows information involved in an exemplary license generation process of a preferred embodiment;

FIG. 9 shows an exemplary deployment of a server agent and client agents for providing dynamic license generation for rights management at client devices in accordance with a preferred embodiment;

FIG. 10 shows basic processing performed by a client agent and a server agent for requesting, generating and applying a license in accordance with a preferred embodiment;

FIG. 11 shows an example of an exchange of an asset between two different policy domains;

FIG. 12 shows a first user interface generated by a client agent for displaying information assets owned by a user in accordance with a preferred embodiment;

FIG. 13 shows a second user interface generated by a client agent for selecting predefined rules to be applied to information assets owned by the user in accordance with a preferred embodiment;

FIGS. 14a-14e show user interfaces generated by a client agent to provide a rule creation wizard for customized creation of rules to be applied to information assets in accordance with a preferred embodiment;

FIG. 15 shows a first user interface generated by a server agent for selecting parameters of user activity to be monitored in accordance with a preferred embodiment;

FIG. 16 shows a second user interface generated by a server agent for providing reports concerning monitored activity in accordance with a preferred embodiment;

FIG. 17 shows a first deployment of a policy engine for providing browser-based access to assets in accordance with an embodiment of the invention; and

FIG. 18 shows a second deployment of a policy engine for providing browser-based access to assets in accordance with an embodiment of the invention.

### DETAILED DESCRIPTION OF PREFERRED EMBODIMENTS

As used herein, the term “assets” describes objects within a system to which behavior regulating policies are applied. In the preferred embodiment, the types of assets include users, devices, information files and processes. In other embodiments, additional types of assets may be defined. For example, records, databases, computational results from hardware or software systems, audit trails, policies, communication paths or signals, representations of monetary value or property, or locations such as physical spaces or objects may also be designated as types of assets to which policies are applied.

In accordance with the preferred embodiment, “policies” govern the “rights” that a system asset may exercise with respect to another system asset. Policies are comprised of one or more “rules,” each specifying a logical combination of conditions that must be fulfilled to yield a grant or denial of one or more rights. Policies typically represent real-world regulations governing the behavior of people, objects and information. Rules typically make the allowance or denial of a right contingent on attributes of assets involved in the exercise of the right, and on the current state of one or more transient conditions (also referred to herein as “facts”). For example, in a preferred implementation of a policy management system, the rights of a user (one type of system asset) with respect to a document (another type of system asset), such as opening, printing, saving, deleting, or transmitting the document, may be governed by a wide variety of policies that contain rules that make the exercise of those rights contingent on factors such as attributes of the particular user, attributes of the particular document, attributes of the particular device that the user is using to access the document, and the existence or non-existence of other facts such as the time of day or the presence or absence of other assets or permissions.

In accordance with embodiments of the invention, policies are used to dynamically generate a “license” in response to a “request” (or rights request) from an asset to exercise a specified right with respect to another asset. The policy decisions are based on the existing state of the system at the time that the request is received, and the resulting license reflects rights exercisable by the requesting asset under those existing circumstances. The license takes the form of data representing a right or rights that may be exercised by the requesting asset with respect to the other asset specified in the request. The license is preferably expressed or translated into a format conventionally used for digital rights management, such as XrML or ODRL. The license is used by processes such as applications or operating systems to govern the subsequent behavior of the requesting asset at the device from which the request was made.

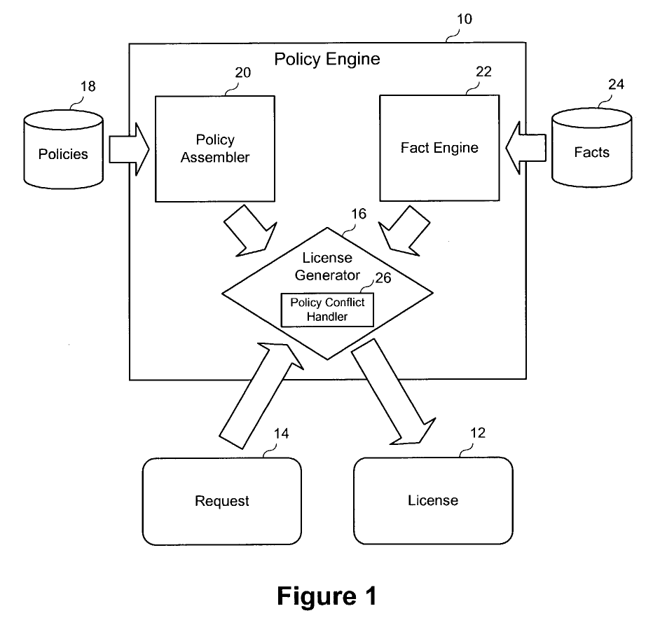

FIG. 1 shows a high-level model of a preferred embodiment of a system for dynamic generation of licenses in response to rights requests through the application of policies. In the preferred embodiment, a policy engine 10 dynamically generates a license 12 in response to a request 14 that specifies a right to be exercised by one asset with respect to another asset. The license is produced by a license generator 16 in accordance with policies that are determined to be relevant to the request. The relevant policies are assembled from a set of stored policies 18, such as a database or a directory, by a policy assembler 20. Each policy is comprised of one or more rules that specify the conditions under which particular rights are granted or denied. Facts that are required for evaluation of the rules contained in the relevant policies are supplied by a fact engine 22 from a set of stored facts 24. The rules of the assembled policies are evaluated in light of the information provided in the request and the relevant facts, and a license is dynamically generated in accordance with application of the rules to the relevant facts. Where there is conflict between the rights granted or denied by various policies, a conflict handler 26 determines which of the conflicting policies prevails.

An important task in dynamic license generation is assembling the policies that are relevant to a given request, and determining the prioritization among policies where multiple policies are applicable to the request. In the presently preferred embodiment, these tasks are facilitated by providing predefined relationships among policies that dictate their relative priorities.

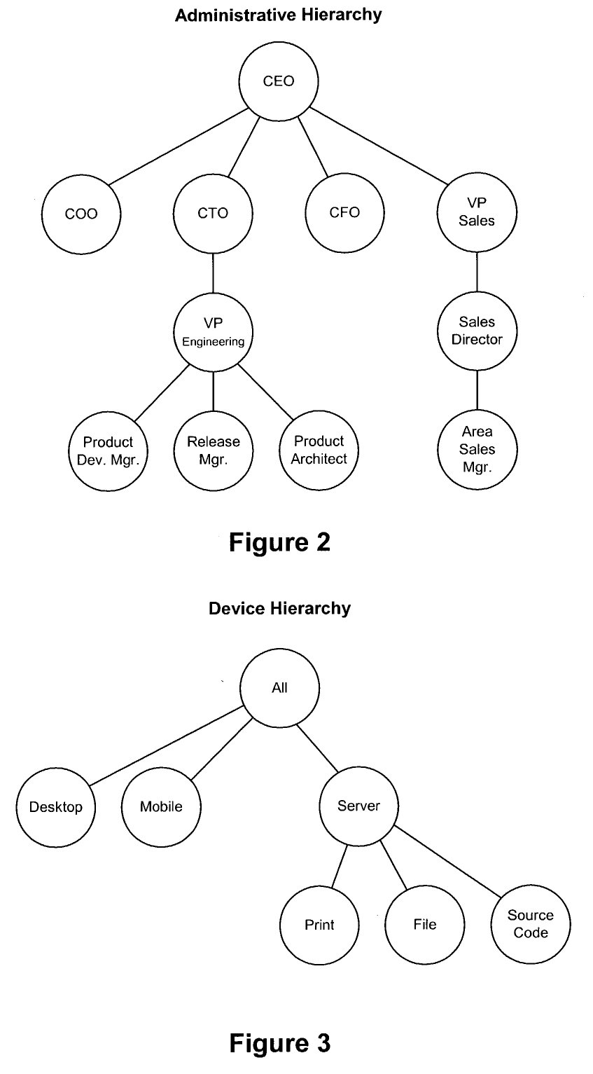

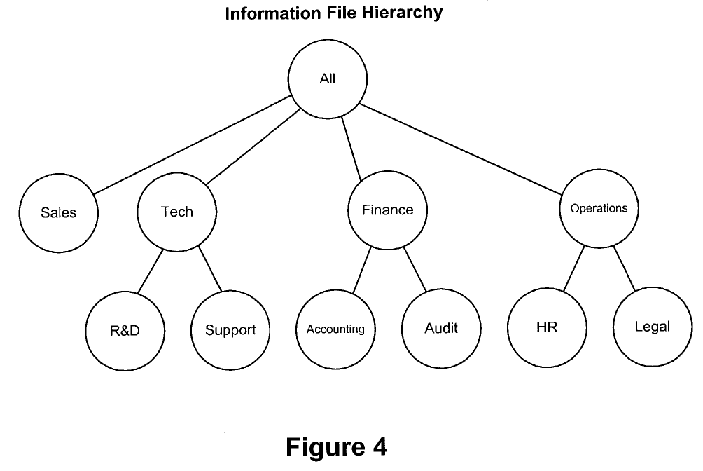

In the preferred implementation of the invention in a policy management system, the predefined relationships among policies are implemented through a combination of policy hierarchies and conflict resolution rules. Each policy is associated with a node of a predefined hierarchy, which establishes its priority with respect to other policies within that hierarchy. Examples of three hierarchies used in a preferred implementation of a policy management system are shown in FIGS. 2-4. In this implementation, the hierarchies correspond to the types of assets that are regulated by the system, and include an administrative (i.e., user) hierarchy (FIG. 2), a device hierarchy (FIG. 3), and an information file hierarchy (FIG. 4). The nodes of each hierarchy represent levels of policy-making authority with respect the type of asset to which the hierarchy corresponds. In the administrative hierarchy, for example, the policy-making authority at the CTO (Chief Technology Officer) level has priority over the policy-making authority at the VP of Engineering level and lower levels, while the policy-making authority at the CEO level has priority over the CTO level and all other levels. Each node of the hierarchy is “owned,” either by a specific user, a user having a certain predefined role (e.g. CEO), or a user who is a member of a predefined group (e.g. Engineering group). The owner or owners of a node are entitled to create policies having the level of authority assigned to that node. For example, the user acting in the role of CEO may be the owner of the CEO node, and therefore has policymaking authority that supercedes that of all others in the administrative hierarchy.

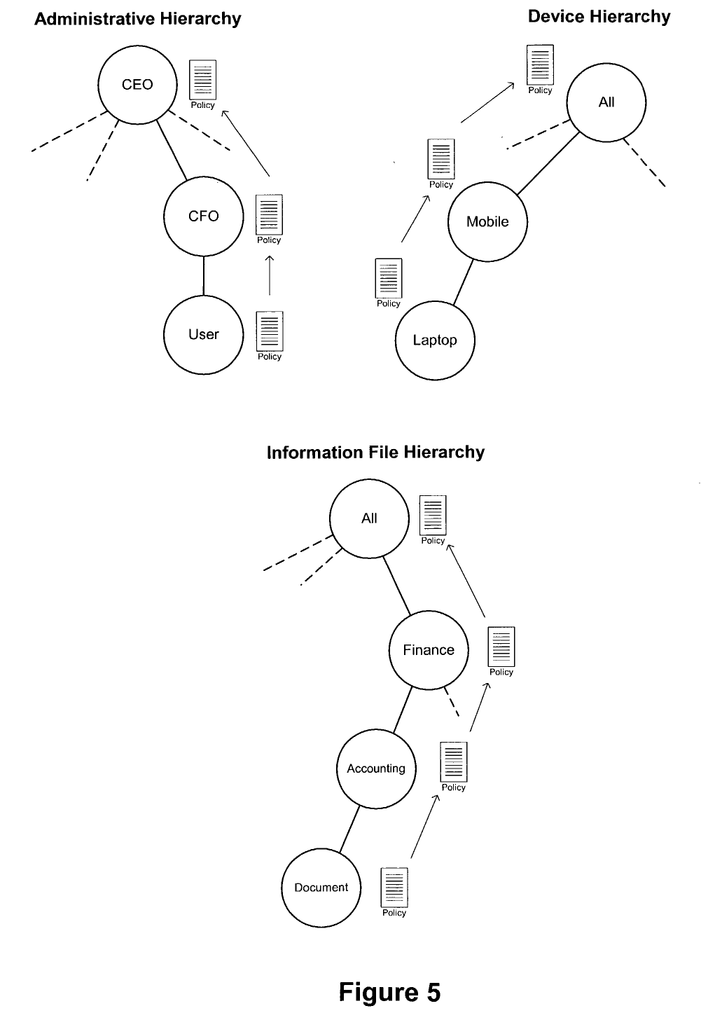

When a request to exercise a right is received, the relevant policies are assembled based upon the assets involved in the request and the policies associated with the node of that asset and the nodes that are superior to the node of that asset within the hierarchy. For example, consider the case in which a user who reports to the CFO requests the right to open an accounting document on his laptop. As shown in FIG. 5, the policy assembly process for responding to this request involves locating the individual assets (the user, the device and the document) within their respective hierarchies, and then collecting the policies applicable at the nodes of those individual assets and at all superior nodes up to the top of the hierarchy. The resulting set of policies collected from each hierarchy is referred to herein as a policy stack and is comprised of all of the policies indicated by the hierarchy to be applicable to the asset. As shown in FIG. 5, each individual asset occupies the lowest level of its respective hierarchy, and may have its own policies.

While the present example performs assembly of policies in real time in response to requests, in other implementations it may be desirable to perform pre-processing of policies in order to pre-assemble policy stacks for various assets so that a required policy stack may be retrieved more efficiently upon receipt of a request. Further, while the present example assumes that all policies at a given level are applicable to all assets beneath that level in the hierarchy, other implementations may utilize a more complex system in which assets may be organized into groups or may be assigned roles, and the policies at each level of the hierarchy may comprise rules that are conditioned upon particular group memberships or asset roles. In such implementations, the policies at each level of the hierarchy above the asset must be analyzed to determine whether they pertain to the group or role of the asset for which the policy stack is being assembled.

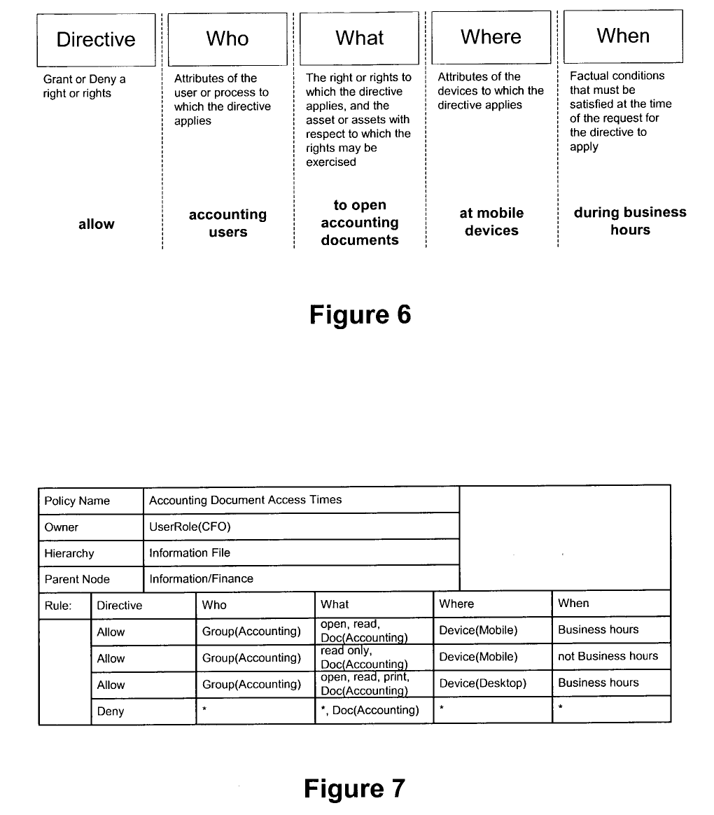

Policies and the processing of policies in dynamic license generation are now examined in more detail. As discussed above, policies are comprised of rules. The preferred implementation of a policy management system utilizes rules that are expressed in a standardized format as shown in FIG. 6. Each rule associates a directive (i.e. granting or denying the exercise of one or more rights) with a set of clauses that must be satisfied to yield the directive. The clauses are of the type “who” (specifying attributes of the users and/or processes to which the directive applies), “what” (specifying the right or rights to which the directive applies and the asset or assets with respect to which those rights may be exercised), “where” (specifying attributes of the devices to which the directive applies), and “when” (specifying conditions that must be satisfied for the directive to apply). In the rule provided as an example in FIG. 6, users who are members of the accounting user group are explicitly permitted to open documents that are classified as accounting documents at devices classified as mobile devices during business hours.

FIG. 7 shows an example of a policy that includes the rule of FIG. 6 and other rules. The policy of FIG. 7 includes identifying information including a title, identification of the policy owner (in this case, the user having the role of CFO), the hierarchy to which the policy belongs, and an identification of its parent node in the hierarchy which establishes the predefined relationship of the policy within the hierarchy. The policy further includes four rules that together comprise the policy of the CFO regarding the times at which users may access accounting documents. In the preferred implementation as shown in FIG. 7, rules are prioritized within each policy by ordering them in terms of priority. Accordingly, the effect of a policy on a given rights request may be analyzed by sequentially evaluating the rules of the policy beginning with the first rule. Each rule is evaluated only if evaluation of preceding rules does not yield a decision.

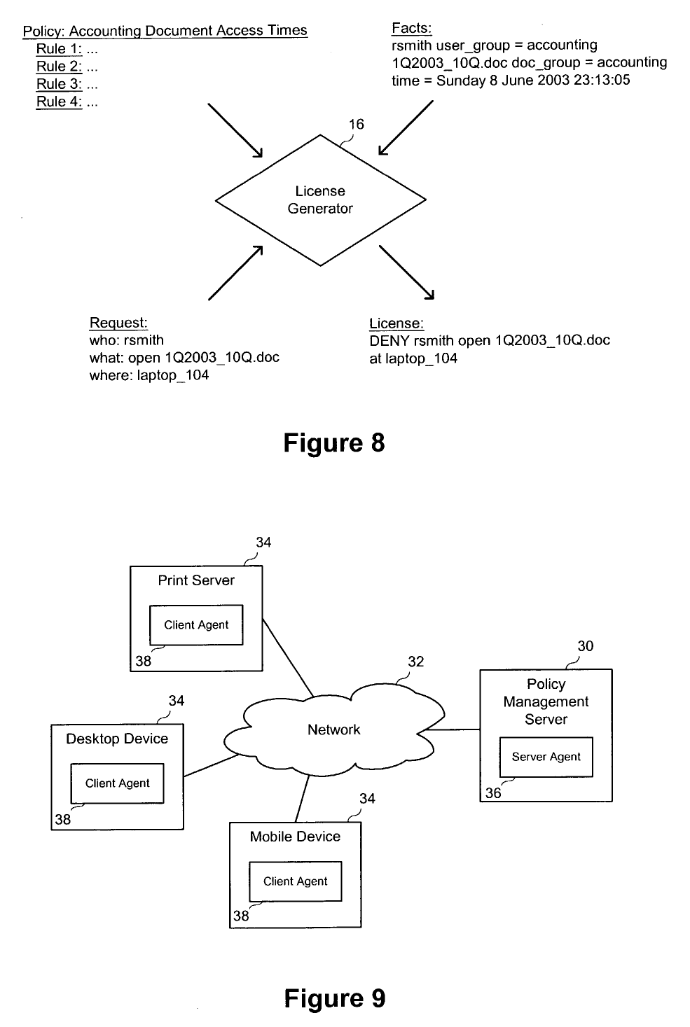

FIG. 8 shows an example of the application of the policy of FIG. 7 in the license generator in response to a rights request. In the example of FIG. 8, it is assumed for purposes of illustration that the policy of FIG. 7 is the only policy determined to be relevant to request. The request received by the policy engine 16 specifies a user, a right to be exercised, a document with respect to which the right is to be exercised, and a device at which the requester wishes to exercise the right. In particular, the user rsmith wishes to open the document 1 Q2003_{—}10Q.doc at the device laptop_{—}104. Using the policy hierarchies as described above, the policy assembler retrieves the policy Accounting Document Access Times, and supplies this policy to the license generator. The various facts required for evaluation of the rules are obtained from the fact engine, including the respective groups of the user, the document, and the device, and the current time and date. The rules are evaluated in order beginning with the first rule. In the present example, the first rule does not yield a decision because the current time is not within business hours. The second rule is then evaluated, but does not yield a decision because it only grants a read only right, and the request is to open the document. The third rule is then evaluated, but does not yield a decision because the requested right is to open the document at a mobile device, whereas the third rule grants open rights to desktop devices. The fourth rule is then evaluated. This rule is effectively an “else” rule that denies all access when access is not allowed under any of the three preceding rules. Therefore, in this example, the applicable policies do not permit the exercise of the requested right, and so the policy engine generates a license that denies the request of the user rsmith to open the document 1 Q2003_{—}10Q.doc at his laptop.

While the example of FIG. 8 involves only one policy, requests in typical implementations will be governed by many different policies that may be contained in several different policy stacks. In such instances, the respective policies of each policy stack are evaluated sequentially beginning with the lowest priority policy. The decisions yielded by each policy are subservient to decisions yielded by higher ranking policies. For example, while the policy owned by the CFO prevents opening of the requested document in the example of FIG. 8, a higher level policy may override that policy under conditions that exist at the time of the request, and in that case the denial under the policy of FIG. 7 is overridden by the grant provided by the higher ranking policy.

Conflicts among decisions yielded by the different policy stacks applicable to a request are resolved in accordance with conflict resolution rules provided in the conflict handler of the license generator. Conflicts may be resolved, for example, based on a predefined ranking among the owners of the conflicting policies, or on other factors.

As noted above and as illustrated in FIGS. 7 and 8, policies may be expressed in terms that are specific to particular groups of assets such as user groups or user roles, device groups, or file groups. As a result, the collection of relevant policies may utilize knowledge of the groups or roles associated with the assets specified in the request. This type of policy collection may be implemented in a number of manners. In one implementation, asset group and role affiliation may be obtained from the fact engine based on the assets specified in the request, and may be supplied to the policy assembler for use in policy assembly. In another implementation, group and role affiliations may be supplied as part of the rights request.

The processes and functions involved in dynamic license generation are preferably implemented in an agent at a server that communicates with devices in the system or in an agent associated with a device, while the processes and functions involved in issuing requests for licenses and regulating the behavior of assets in accordance with licenses is preferably implemented in agents that reside on or are associated with each device within the system. A schematic diagram showing basic elements of an embodiment providing license generation at a server is provided in FIG. 9. In this configuration, a policy management server 30 communicates through a network 32 with system devices 34. A server agent 30 in the policy management server 30 receives rights requests from the devices 34 and responds by transmitting dynamically generated licenses to the devices 34. The server agent also preferably provides other services such as presence and availability management, further details of which are provided in the documents incorporated herein by reference. Within each device, a client agent 36 communicates with the server agent to request and receive licenses. The client agent also preferably provides other services such as location reporting, further details of which are provided in the documents incorporated herein by reference.

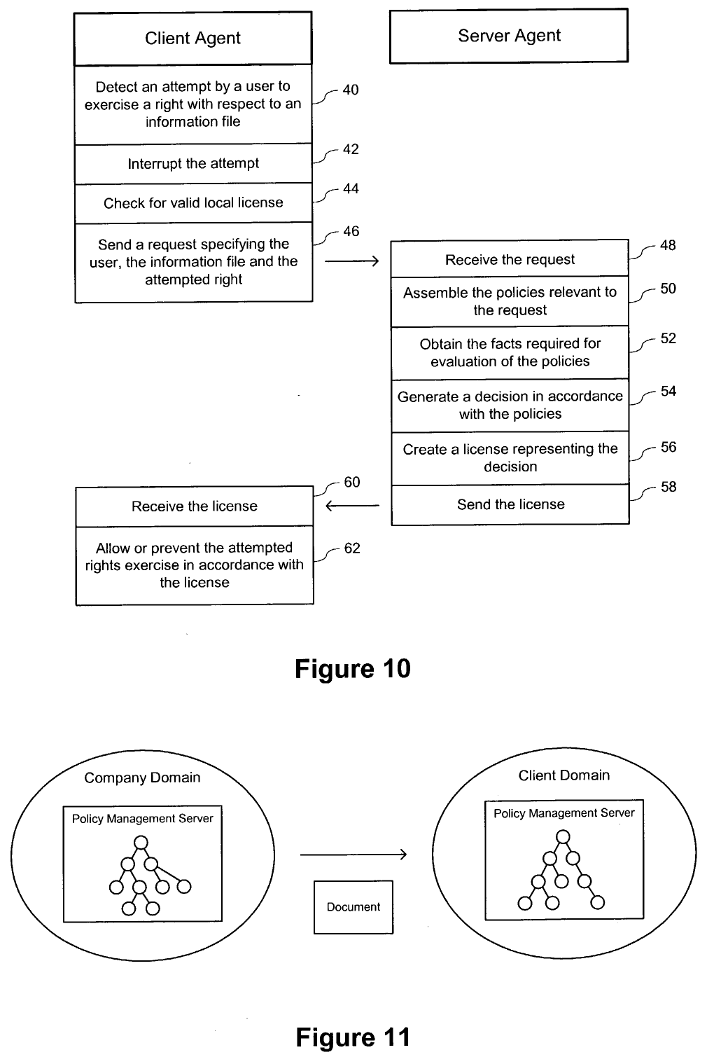

The basic processing performed by the client agents and server agent during license request and generation are illustrated in more detail in FIG. 10. Initially a client agent resident on a device detects (40) an attempt by a user to exercise a right with respect to an information file such as a document, application, email message, spread sheet, image, audio or video file, or other type of information file. Such detection is typically provided by filters that monitor the activities of drivers in the client device such as file system drivers, network drivers and device drivers. The types of rights exercises that are monitored may be tailored to the specific implementation, but generally include actions such as opening, reading, writing, deleting, executing, backing up, restoring, sending or receiving, editing, embedding, extracting, copying, transferring, loaning, printing and exporting. Upon detection, the attempt is interrupted (42), such as by suspending the execution of an application or by trapping a request to exercise the right. The client agent then typically checks (44) to determine whether there is a valid local license governing the rights of the user with respect to the information file. For purposes of the present example, it is assumed that there is no valid local license, however this check may result in other determinations that lead to a different set of actions, as discussed further below. Upon determining that there is no valid local license, the client agent sends (46) a request to the server agent that specifies the user, the information file, and the right that is attempted to be exercised.

Upon receiving (48) the request, the server agent assembles (50) the policies that are relevant to the request. As discussed above, policy assembly is preferably facilitated by hierarchical policy structures corresponding to each type of regulated asset that allows the creation of policy stacks for evaluation. However, other manners of policy assembly utilizing other forms of predefined relationships may be utilized, as discussed herein. In addition to assembling policies, the server agent acquires (52) facts that are required to evaluate the assembled policies. Facts may be assembled for use in policy assembly and for use in policy evaluation. A wide variety of facts may be acquired. Typical facts that may be acquired include group memberships and roles of users, information files and devices. Other types of facts that may be acquired include current information made available from other applications and systems, such as clocks, calendars, physical security controllers, card readers, biometric scanners, or agents that monitor system or user states or behaviors. Upon acquiring the necessary facts, a decision is generated (54) in accordance with the applicable policies. Decision generation preferably involves evaluating the rules within each policy, beginning with the highest priority rule within each policy, and beginning with the lowest ranking policy in each policy stack. Decisions yielded by higher ranking policies override conflicting decisions of lower ranking policies within the same policy stack, and conflicts among the decisions produced by each policy stack are resolved through the application of additional predefined conflict resolution rules. A license is then created (56). The license represents the decision generated in accordance with the relevant policies. The license is preferably represented in a known rights management format such as XrML or ODRL, but may be represented in another form. The license is sent (58) to the client agent in response to the client agent's request. Upon receiving (60) the license, the client agent allows or prevents (62) the exercise of the right by the user in accordance with the license.

While the example of FIG. 8 shows a request that includes minimal information identifying a user, document, action and device, in other embodiments a variety of additional information may be included in the request. One type of information that may be included is an indication of a time constraint, the priority of the request or of the quality of service required in responding to the request. Since the policy engine will typically handle large numbers of requests, license generation may be slow in some instances. Specification of a time constraint, priority or required quality of service allows the policy engine to prioritize the order in which it responds to requests. such requests may be limited to certain types of users and may be subject to confirmation of the credentials required for such a request.

Another type of information that may be included in the request is a format in which the license is to be generated. Several formats for license data such as XrML and ORDL are currently known, and the type needed may depend on the application or operating system that is operating on a client device. While the examples herein have assumed for simplicity that the license generated by the policy engine represents a single decision regarding the exercise of a single right with respect to a single asset, in other implementations the license may be more expansive in terms of both its scope and its duration. For example, rather than addressing a single right, the license may take the form of a decision table that governs both the exercise of the requested right and other rights that would commonly be requested by the user with respect to the specified asset or other related assets. For example, in response to a request to view the contents of a file system folder, a license may be generated that addresses the user's rights with respect to all files contained in the folder. To generate such a license, an appropriate decision table may be constructed in the server agent during the policy analysis phase of processing, and the license may be generated in a form that represents all of the scenarios and decisions reflected in the decision table. Such a license may then be used locally by the client agent to regulate the user's activities with respect to files contained in the folder. The license may also be used for additional purposes such as regulating file availability by preventing display to the user of any files to which the user has no rights.

The license may also be provided with an expiration such that it may be retained and used locally for a period of time. The expiration may be based on a fixed period of time, or may be contingent on events such as changes in facts whose existence was a condition precedent to the generation of a particular right or rights authorized by the license. In the latter type of license, the monitoring of changes of such facts may be performed in the server agent, with updated facts, license expiration notices or new licenses being pushed to the client agent as necessary, or the client agent may monitor facts by requesting fact updates from the server agent and invalidating a license when a necessary condition is no longer satisfied.

The examples provided above have assumed that the exercises of rights have occurred entirely within a single policy domain. However, in some applications, evaluation of policies from more than one domain may be required. FIG. 11 shows an example of an interaction that involves multiple policy domains. In this example, an electronic document is sent from a company to its client. The company and its policies constitute one policy domain, while the client and its policies constitute a separate policy domain. In other words, each domain has its own sets of policies that regulate the behavior of assets within the domain. However, in a case such as that illustrated in FIG. 11, an asset of one domain attempts to exercise a right over an asset from another domain. For example, a user in the client domain may wish to modify the document received from the company domain. In this case, rights with respect to the document should be analyzed in view of both the client's policies and the company's policies. To facilitate this type of policy analysis, the policy management server in the client domain must be made aware that the document is an asset that belongs to a different domain. This may be implemented in a variety of manners. In one implementation, the document may be accompanied by an identifier of the domain that it is owned by, and upon detection of this identifier at the policy management server, communication is established between the servers to supply all relevant policies to the receiving domain. In another implementation, policies accompany the document that is transmitted to the new domain. These policies may comprise a complete set of policies that are relevant to the document, or may comprise an incomplete set of policies that, for example, cause the server of the receiving domain to inquire for additional policies.

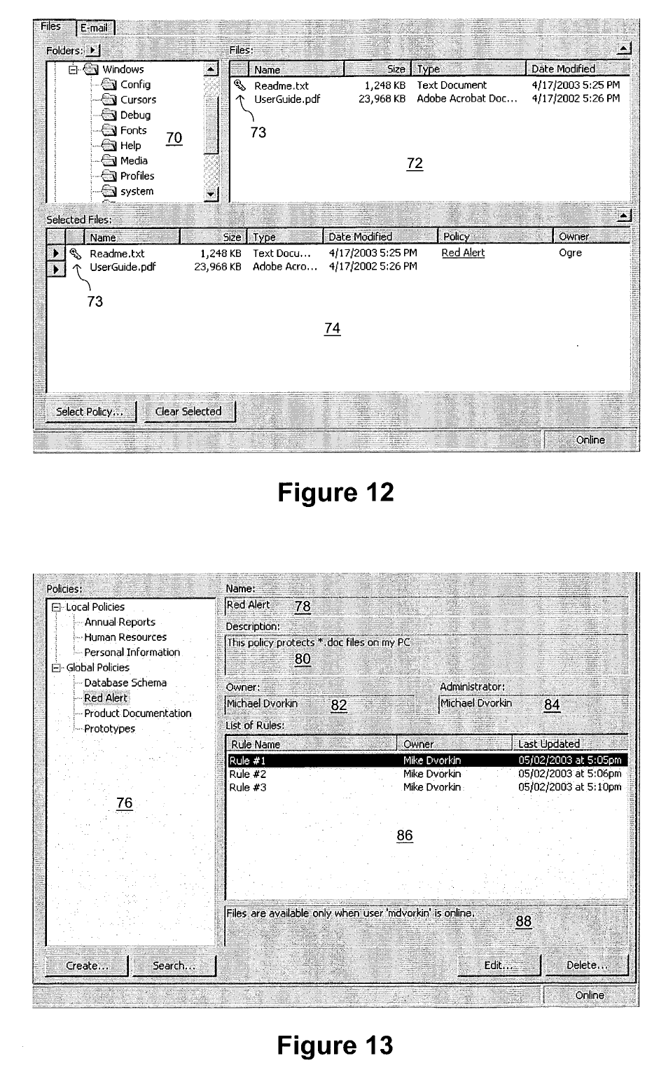

The license request, license generation and rights regulation processes described above are background processes that are generally not visible to users during normal system operation. However the client agent and server agent also preferably provide a variety of user services. FIGS. 12, 13 and 14a-14e show user interfaces generated by a preferred client agent to allow a user to create policies governing information files owned by the user. FIG. 11 shows a user interface that allows the user to view information assets owned by the user. The information assets are located using a file tree display area 70 and a file list display area 72. The list selectively displays files over which the user has policy making authority based on factors such as the user's group membership and role. An icon 73 is used to indicate files that are controlled by policies owned by the user. Selected files are displayed in a selected files window 74 from which they may be operated on to create or remove policies. As seen at the top of FIG. 11, tabs allow policy creation to be performed with respect to both file system files and email messages.

FIG. 12 shows a user interface generated by the client agent upon initiation of a policy creation process through operation of a select policy button provided in the preceding user interface. This user interface includes a policy display section 76 that displays predefined policies that may be applied by the user to files owned by the user. The predefined policies are typically designed to reflect specific information access and security policies that have been formulated by the organization in which the system is implemented, and the predefined policies are made available to the user selectively based on factors such as the user's group membership and role. It is preferred that sets of policies are formulated for both local application to single files, and global application to all files of a particular type that are owned by the user.

The user interface of FIG. 12 further includes a field 78 for displaying the name of a selected policy, a field 80 for describing the types of files encompassed by the policy, a field 82 naming the policy owner, and a field 84 naming the policy administrator. A rules display 86 provides a list of the rules that are contained within the predefined policy, and an explanation display 88 provides a plain language explanation of a rule that has been selected within the rules display. Each rule may be individually selected for editing or deletion.

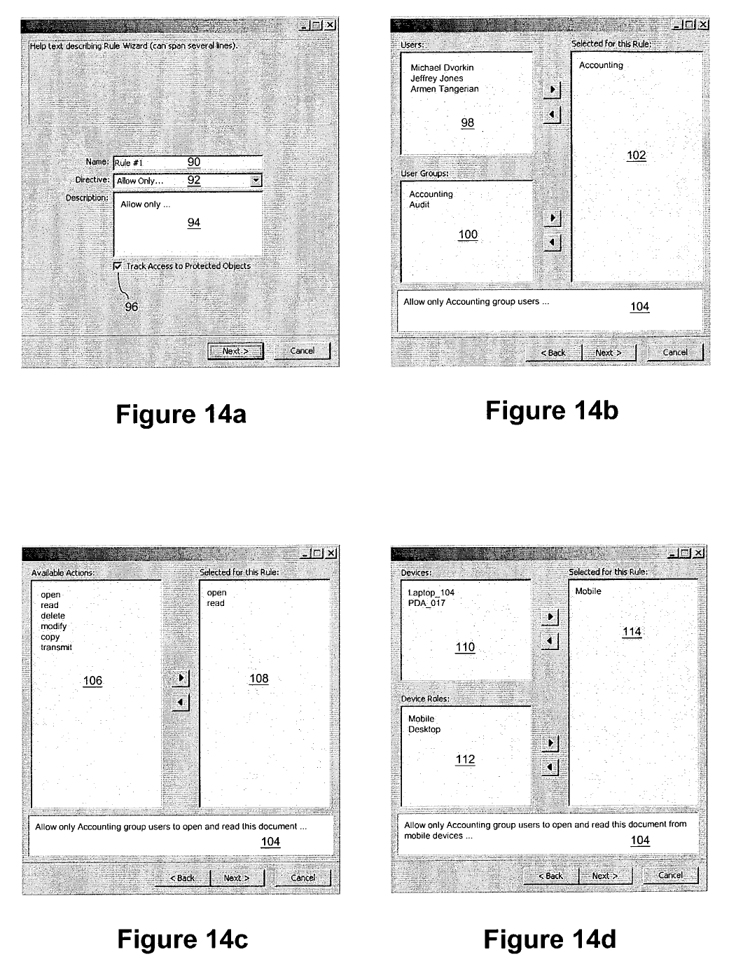

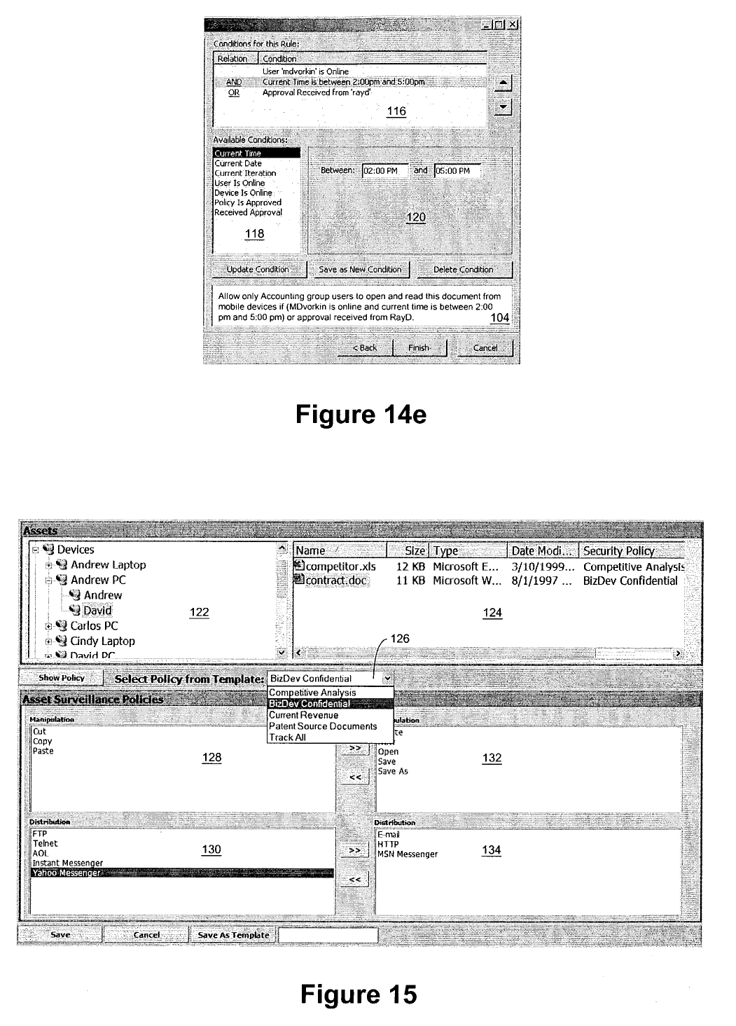

Operation of a create button provided in the user interface of FIG. 13 initiates a rule creation wizard that presents the user interfaces shown in FIGS. 14a-14e for creating a customized rule to be included in an existing policy or a new policy. The first wizard user interface shown in FIG. 14a presents fields for naming the rule 90 and selecting a directive 92. A display area provides a plain language description of the selected directive. A field 96 is also provided that may be checked to indicate that accesses to the assets protected by the rule should be tracked. This and other audit trail features in accordance with the invention are discussed in more detail below.

The next user interface of the wizard shown in FIG. 14b provides displays of lists of users 98 and user groups 100 that may be selected for inclusion in the “who” portion of the rule, and a separate display 102 of selected users and groups. A display area 104 at the bottom of the user interface provides a plain language version of the rule as it is constructed.

The third user interface of the wizard shown in FIG. 14c provides a display 106 of available actions (rights) that may be selected for inclusion in the “what” portion of the rule, and a separate display 108 of selected actions.

The fourth user interface of the wizard shown in FIG. 14d provides displays of lists of devices 110 and device groups or roles 112 that may be selected for inclusion in the “where” portion of the rule, and a separate display 114 of selected devices and groups.

The fifth user interface of the wizard shown in FIG. 14e provides a display 118 of available conditions that may be selected for inclusion in the “when” portion of the rule. An adjacent display area 120 presents fields that may be filled in for the particular condition selected. A further display area 116 shows the selected conditions and logical operators used to relate the conditions. Update, save and delete buttons are provided for initiating corresponding features. When all desired conditions are selected, the operation of a finish button saves the rule in the corresponding policy, and the user is returned to the user interface of FIG. 13, where the new rule will be displayed along with other rules in the same policy.

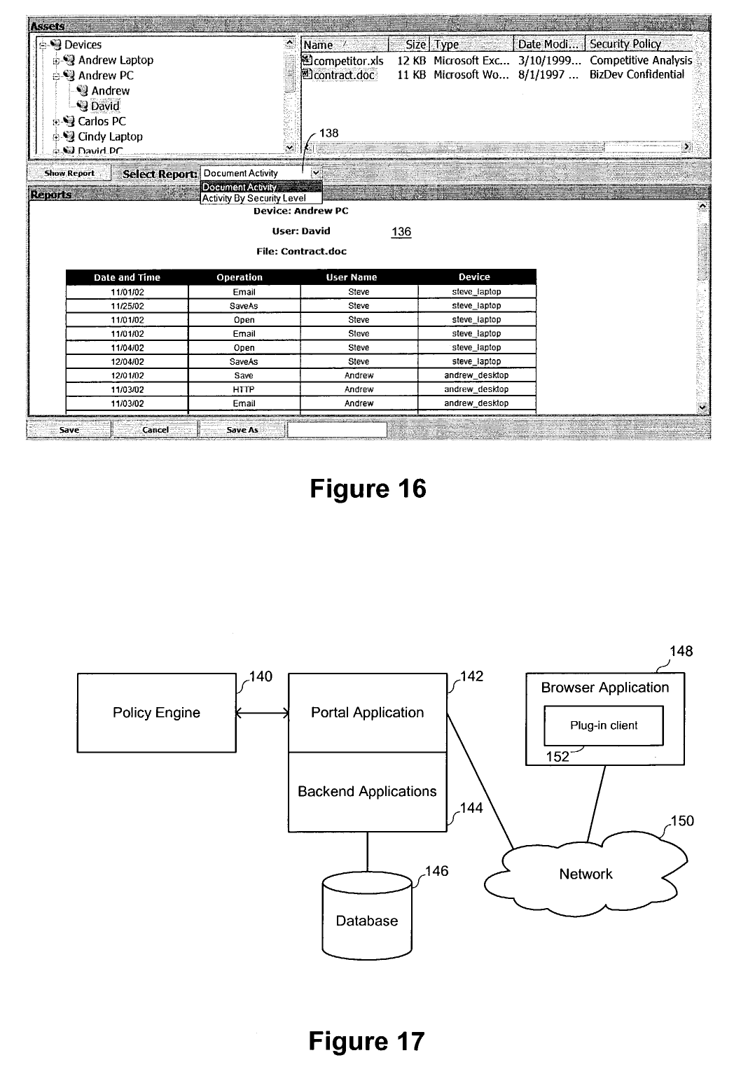

FIGS. 15-16 show examples of user interfaces generated by the server agent in accordance with the preferred embodiment for providing tracking of user activities with regard to various assets. The user interface of FIG. 15 allows a user to select a user, device or file for which activity is to be monitored. The user interface includes a display area 122 that lists system assets including users, devices and files. Assets selected from the list for monitoring are shown in an adjacent display area 124. A list 126 of monitoring policies allows the user to select a particular type of monitoring to be performed. Additional display areas 128, 130 allow the user to select particular activities to be monitored, and selected activities are listed in adjacent display areas 132, 134.

The user interface shown in FIG. 16 allows the user to view reports concerning monitored activity. A display area 136 displays a particular type of report as selected from a list 138 of available report types.

Monitoring activities such as those shown in FIGS. 15-16 may be applied in other ways in addition to generation of simple activity reports. For example, in one preferred implementation, metrics are applied to the activities performed with regard to assets to evaluate the relative value of those assets and to generated policies for those assets based on their determined values. For example, documents created and used for significant amounts of time by users having high ranking roles may be identified based on these activities as documents that have high value and therefore should receive a certain level of policy protection. In preferred implementations, such determinations may be used to associate predetermined policies with such assets, or to create new policies for such assets, or to revise current policies associated with such assets.

Other services preferably provided by the server agent include testing of policies prior to their actual implementation. One type of testing that is preferably provided by the server is conflict identification, wherein conflicts with existing policies that will be caused by a proposed policy are identified through processing in the policy engine. This allows revision of proposed policies for better integration with other policies. Another type of testing that is preferably provided is evaluation of the effects that proposed policies would have on user activity using ongoing or historical activity data. Testing using a data set representing real user actions allows identification of undesirable policy effects without actually enforcing the policy on active users, allowing revision of proposed policies to better suit organizational needs.

While the implementations of the invention described to this point have assumed that the policy engine is deployed at a server that communicates with client devices through a network in a conventional client-server arrangement, in other implementations it may be desirable to implement that client agent as a browser plug-in. FIG. 17 shows one example of how such a deployment may be facilitated. In this deployment, a policy engine 140 communicates with a web server device comprising a portal application 142, back end applications 144 and a database 146. A browser application 148 interface with the web server through a network 150. A plug-in client 152 in the browser application interacts with the policy engine at the server to obtain licenses for accessing content provided by the web server.

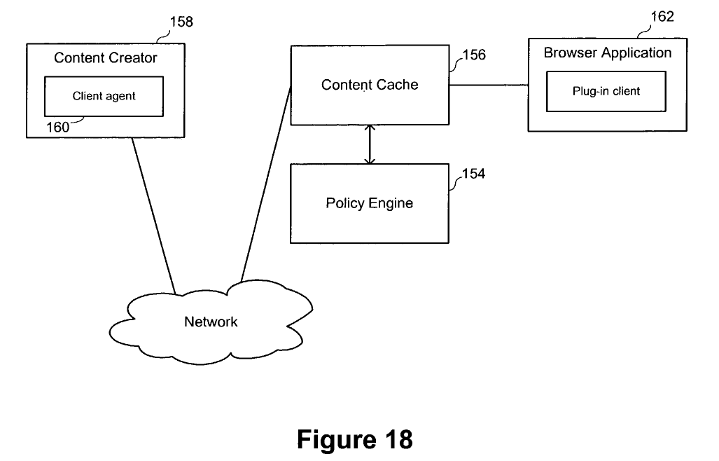

FIG. 18 shows an alternative deployment of policy engine functionalities for browser-based clients. It is conventional practice to cache copies of content files at locations at the network edge so that the content can be obtained from a cache that is relatively close to the requester. Under such circumstances, it is not desirable to provide a policy engine only at the server that serves as the origin of the content, since this will vastly increase traffic at that server. Accordingly, in the embodiment of FIG. 18, a policy engine 154 is provided in conjunction with a content cache 156 at the network edge. Policies for content are created by the content creator 158 using a client agent 160, and are encapsulated with the content in the cache. When a request for particular content is received at the cache from a browser application 162, the request is evaluated by the policy engine 154 in accordance with the policies encapsulated with the content.

The use of implementations of the invention for document security and policy management is highly applicable as a solution for several current needs. One such application is for control of financial documents in publicly traded corporations in accordance with the Sarbanes-Oxley Act of 2002. Some of the regulations established by this act require publicly traded companies to provide selected financial documents to two external auditors within a specified time frame on an annual basis, and requires financial documents to be archived and maintained for a period of seven years. The type of documents to be made available would generally be considered confidential and subject to destruction. Using the policy based controls described herein, policies may be easily created and implemented to prevent deletion of all such documents for seven years, and to provide tightly controlled access to external auditors within fixed periods of time, despite the confidentiality of those documents. These policy changes are simply implemented using the policy creation tools described herein, and may be given precedence over other potentially conflicting policies through appropriate definition of the relationship of the policy to existing policies, such as by establishing the policy at a superior location in a policy hierarchy.

Another current need addressed by the preferred embodiment of the present invention is protection of patient healthcare records in accordance with the Health Insurance Portability and Accountability Act, commonly referred to by its acronym HIPAA. HIPAA establishes a complex set of record regulations that must be adhered to by health insurance providers and medical service providers. For example, both medical service providers and health insurance providers must maintain the confidentiality of patient records, and must maintain audit trails showing all actions taken with respect to such records. In addition, patients must be made aware of any time a party is provided with a copy of their records. The preferred embodiment of the present invention may be adapted to treat patient records and their audit trails as assets and to regulate actions taken with respect to those assets through the creation of appropriate rules and polices as described herein.

A further current need addressed by the preferred embodiment of the present invention is compliance with 21 CFR part 11 by pharmaceutical companies. 21 CFR part 11 establishes standards for record retention by companies performing drug discovery research and clinical testing. For example, companies are required to create audit trails for all digital information, to maintain all records from research and clinical trials and make them available for audit on demand, and to maintain records in a secure and encrypted form. Documents and audit trails may therefore be treated as assets to which appropriate policies are applied satisfy each of these requirements.

Other similar implementations may be tailored to satisfying other regulatory and compliance rules, such as those of the Federal Information Privacy Standard or the ISO 17799 standard for information security.

The embodiments discussed herein have been described as performing policy evaluation through a collecting process that utilizes predefined rule-based relationships among policies. However, in some instances the large number of policies involved may make such processing extremely burdensome. In such cases it is desirable to implement policy collection schemes that optimize collection and reduce the number of irrelevant policies inspected. One optimization approach is to use a probability based system to identify the policies most likely to be relevant to a given interaction of assets. For example, a codebook may be produced for a combination of a user, device and a file. The codebook presents a probability of relevance for each policy maintained by-the system. Accordingly, when a request is received, the codebook for the combination of assets specified in the request is consulted to determine the policies having the highest probabilities of relevance to the request, and those policies are assembled and analyzed. Initial codebooks may be generated through preprocessing, such as through use or analysis of historical data, and their relevance scores for each policy may then be updated as the policies are used in decision making in response to actual requests.

While the preferred embodiments described herein focus on the application of the invention to policy management systems, alternative embodiments of the invention may be directed to regulation of other types of assets. In general terms, the invention may encompass the regulation of any type of asset for which policies may be defined and to which behavior regulation may be applied through the operation of electronic or data processing devices. For example, while the preferred embodiment regulates user access to documents, alternative embodiment may regulate, for example, user access to physical spaces or objects, based on policies governing access to the spaces or objects, and the satisfaction of expressed conditions by current facts, such as the presence of particular individuals, a current time that is within defined access times, or the absence of prohibitive conditions such as transient high security conditions.

The preferred embodiments set forth herein are intended to describe the best modes presently known to the inventors and to provide a thorough understanding of the present invention by way of specific examples. However, these embodiments are particular to specific implementation goals, and those skilled in the art will be able to devise further embodiments which, although not explicitly described or shown herein, embody the principles of the invention, and are included within its spirit and scope. Furthermore, all examples and conditional language that have been recited herein are principally intended to aid the reader in understanding features of certain implementations of the invention and are not to be construed as limiting the scope of the invention to such specifically recited examples and conditions. Moreover, all statements herein reciting principles, aspects, and embodiments of the invention, as well as specific examples thereof, are intended to encompass both structural and functional equivalents thereof. It is intended that such equivalents include both currently known equivalents as well as equivalents developed in the future, i.e., any elements developed that perform the same function, regardless of structure. Thus, for example, it will be appreciated by those skilled in the art that the block diagrams herein represent conceptual views of programmable devices and programmed processes that embody the principles of the invention. Similarly, it will be appreciated that flow charts, flow diagrams, pseudocode and the like represent various processes which may be substantially represented in computer readable media and so executed by a computer or processor. The functions described and illustrated herein may be provided through the use of programmable devices employing a single dedicated processor, a single shared processor, or a plurality of individual processors, some of which may be shared. The functions described and illustrated herein may also be distributed across multiple programmable devices. Moreover, explicit use of the terms “device”, “server”, or “computer” should not be construed to refer exclusively to hardware capable of executing software, and may implicitly include, without limitation, digital signal processor (DSP) hardware, read-only memory (ROM) for storing software, random access memory (RAM), and non-volatile storage. Thus, while the embodiments illustrated in the figures and described above are presently preferred, it should be understood that these embodiments are offered by way of example only. The invention is not limited to a particular embodiment, but extends to various modifications, combinations, and permutations that fall within the scope of the appended claims and their equivalents.

What is claimed is:

1. A method for regulating the behavior of assets within a system, comprising:
receiving a request for a license governing the exercise of a right by a first system asset with respect to a second system asset;
determining policies relevant to the exercise of the right by the first system asset with respect to the second system asset;
acquiring facts required for evaluation of the policies;
dynamically generating a license governing the exercise of the right by the first asset with respect to the second asset in accordance with the relevant policies and the acquired facts; and
providing the license to the requester of the license.

2. The method claimed in claim 1, wherein the first asset is a system user and the second asset is an information file, and the right is an action to be taken by the user with respect to the information file.

3. The method claimed in claim 2, wherein the information file is one of a document, a spreadsheet, a data file, data packet, buffer stream, real time communication, an audit trail, a policy, an email message, an image file, an audio file, and a video file.

4. The method claimed in claim 2, wherein the request further specifies a device at which the user wishes to exercise the right with respect to the information file.

5. The method claimed in claim 1, wherein the system assets include users, processes, devices and information files.

6. The method claimed in claim 5, wherein the system assets further include applications.

7. The method claimed in claim 1, wherein the request specifies a format in which the license is to be provided, and the license is provided in the specified format.

8. The method claimed in claim 7, wherein the format is one of XrML, ODRL and a tagged representation.

9. The method claimed in claim 1, wherein the request comprises an indication of a quality of service required in processing of the request, and said determining, acquiring and generating are performed in accordance with said quality of service.

10. The method claimed in claim 9, wherein the quality of service involves one of speed of processing and priority of processing.

11. The method claimed in claim 1, wherein a quality of service for said determining, acquiring and generating is determined in accordance with a quality of service rule.

12. The method claimed in claim 1, wherein the policies relevant to the exercise of the right are determined from among multiple policies having predefined relationships indicating their relative priorities.

13. The method claimed in claim 12, wherein the predefined relationships among policies are expressed in the form of a policy hierarchy arranged according the relative priorities of policies.

14. The method claimed in claim 13, wherein a hierarchy of policies is established for each type of asset defined in the system.

15. The method claimed in claim 13, wherein the predefined relationships among policies are further expressed in the form of conflict resolution rules for resolving conflicts among decisions yielded by policies of different hierarchies.

16. The method claimed in claim 1, wherein the second asset is an information file and the policies relevant to the exercise of the right are encapsulated with the information file.

17. The method claimed in claim 16, wherein the information file is stored in a network cache, and said method is performed in a device in communication with the cache.

18. The method claimed in claim 1, wherein relevant policies are retrieved as pre-assembled policy stacks corresponding to the first asset and the second asset.

19. The method claimed in claim 1, wherein relevant policies are determined in accordance with probabilities associated with each policy.

20. The method claimed in claim 1, wherein relevant policies are determined in accordance with probabilities associated with rules within policies.

21. The method claimed in claim 1, wherein the facts acquired for evaluation of the policies include group affiliations of the first and second asset.

22. The method claimed in claim 1, wherein the acquired facts comprise the current states of transient conditions upon whose states the exercise of rights are made contingent in said policies.

23. The method claimed in claim 22, wherein said current state is the current state of a physical security system.

24. The method claimed in claim 1, wherein the method is implemented on a server that receives requests from client agents at devices of the system.

25. The method claimed in claim 1, wherein the method is implemented in a client agent at a device where the first asset wishes to exercise the right with respect to the second asset.

26. The method claimed in claim 1, wherein the relevant policies are determined from among policies implementing regulations of the Health Insurance Portability and Accountability Act (HIPAA).

27. The method claimed in claim 1, wherein the relevant policies are determined from among policies implementing regulations of the Sarbanes-Oxley act.

28. The method claimed in claim 1, wherein the relevant policies are determined from among policies implementing regulations of part 11 of section 21 of the Code of Federal Regulations.

29. The method claimed in claim 1, wherein the relevant policies are determined from among policies implementing regulations of the Federal Information Privacy Standard.

30. The method claimed in claim 1, wherein the relevant policies are determined from among policies implementing regulations of the ISO 17799 standard for information security.

31. The method claimed in claim 1, further comprising:
dynamically generating a second license in response to the request upon a change of a fact required for evaluation of the license; and
providing the second license to the requester such that the second license superceded the previous license.

32. The method claimed in claim 1, wherein said policies dynamically change in response to changes in facts.

33. The method claimed in claim 32, wherein said policies dynamically change in response to time proximity to an event.

34. The method claimed in claim 32, wherein said policies dynamically change in response to a session parameter.

35. The method claimed in claim 32, wherein said policies are policies that control execution of web services and said policies dynamically change based on one of the status of other assets, a level of activity, and a virus warning.

36. The method claimed in claim 1, wherein determining said policies comprises obtaining policies from an outside domain to which one of said first and second asset belongs.

37. A programmable device for regulating the behavior of assets within a system, the device comprising a computer readable medium storing programming code for performing processing comprising:
receiving a request for a license governing the exercise of a right by a first system asset with respect to a second system asset;
determining policies relevant to the exercise of the right by the first system asset with respect to the second system asset;
acquiring facts required for evaluation of the policies;
dynamically generating a license governing the exercise of the right by the first asset with respect to the second asset in accordance with the relevant policies and the acquired facts; and
providing the license to the requester of the license.

38. A method for creating a policy for regulating the behavior of assets within a system, comprising:
monitoring activities with respect to an asset of the system;
applying metrics to the monitored activities to derive a value for the asset; and
creating a policy for governing behavior with respect to the asset in accordance with the assigned value.

39. The method claimed in claim 38, wherein creating a policy comprises selecting a policy from among predefined policies.

40. The method claimed in claim 38, wherein creating a policy comprises revising a policy governing behavior with respect to the asset.

41. A method for assessing the effects of a proposed policy for regulating the behavior of assets within a system, comprising:
defining relationships between the proposed policy and other system policies; and
evaluating the proposed policies and other policies of the system in accordance with said predefined relationships to identify conflicting decisions yielded by the proposed policy and the other policies.

42. A method for assessing the effects of a proposed policy for regulating the behavior of assets within a system, comprising:
defining relationships between the proposed policy and other system policies;
monitoring decisions yielded by the proposed policy in response to one of current system activities and historical system activities without enforcing the decisions yielded by the proposed policy.

43. A method for assessing the effects of a proposed policy for regulating the behavior of assets within a system, comprising:
defining relationships between the proposed policy and other system policies;
monitoring decisions yielded by the proposed policy in response to one of current system activities and historical system activities while selectively enforcing the decisions yielded by rules within the proposed policy.

44. A programmable device for regulating the behavior of assets within a system, the device comprising a computer readable medium storing programming code for performing processing comprising:
displaying a list of system assets owned by a user of the client device; and
providing tools enabling the user to perform at least one of:
associating a predefined policy with a system asset owned by the user;
modifying a rule of a policy associated with a system asset owned by the user;
modifying a policy associated with a system asset owned by the user;
creating a new policy and associating the policy with a system asset owned by the user.

45. The programmable device claimed in claim 44, wherein the list of system assets owned by the user is determined in accordance with a predefined role associated with the user.

46. A programmable device for regulating the behavior of assets within a system, the device comprising a computer readable medium storing programming code for performing processing comprising:
monitoring the behavior of specified assets within the system; and
displaying reports concerning the behavior of said specified assets.

47 The programmable device claimed in claim 46, wherein said processing further comprises enabling a user to specify assets to be monitored and actions to be monitored.

48. A method for creating a policy for regulating the behavior of assets within a system, comprising:
monitoring activities with respect to an asset of the system;
applying metrics to the monitored activities to derive a value for the asset; and
creating a policy for governing behavior with respect to the asset in accordance with the derived value.
